(19) United States
(12) Patent Application Publication
(10) Pub. No.: US 2012/0019672 A1
(43) Pub. Date: Jan. 26, 2012

(54) INTERNET PROTOCOL CAMERA FOR VISUAL MONITORING SYSTEM

(75) Inventor: MING-CHIH HSIEH, Tu-Cheng (TW)

(73) Assignee: HON HAI PRECISION INDUSTRY CO., LTD., Tu-Cheng (TW)

(21) Appl. No.: 12/946,981

(22) Filed: Nov. 16, 2010

(30) Foreign Application Priority Data
Jul. 26, 2010 (TW) 99124573

(51) Int. Cl. H04N 5/225

(52) U.S. Cl. 348/207.1; 348/E05.024

(57) ABSTRACT

An Internet protocol (IP) camera includes an image capturing unit for capturing images, a distant monitoring unit for receiving the captured images as digital signals through a communication network, and a near monitoring unit receiving captured images as analog signals through a coder/encoder (CODEC) unit. The near monitoring unit is positioned near the image capturing unit, and the IP camera is operated according to the images displayed by the near monitoring unit to adjust visual monitoring parameters thereof, thereby adjusting the IP camera to a desired monitor status.

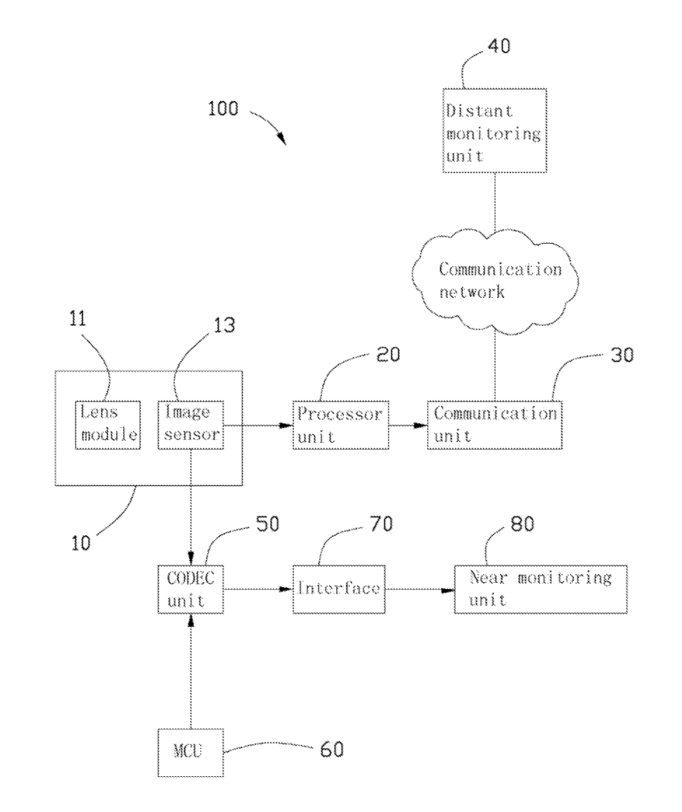

### BACKGROUND

1. Technical Field

The present disclosure relates to cameras for visual monitoring systems, and particularly to an Internet protocol (IP) camera for visual monitoring systems.

2. Description of Related Art

Most cameras used in conventional visual monitoring systems for capturing images are closed-circuit television (CCTV) cameras. Generally, a CCTV camera transforms captured images into analog signals, and transmits the analog signals to televisions at predetermined positions. The televisions receive the analog signals and transform the analog signals into images to display. Since the televisions can independently transform the analog signals into images to display, when a CCTV camera is installed, a television can be positioned near the CCTV camera and directly connected to the CCTV camera to display images captured by the CCTV camera. Thus, visual monitoring parameters of the CCTV camera, such as position, visual angle, and definition, can be easily detected and adjusted according to the images displayed by the television, such that the CCTV camera obtains a desired monitor status.

Nowadays, IP cameras are also used in visual monitoring systems to capture images. IP cameras generally transform captured images into digital signals, and transmit the digital signals to predetermined communication networks, such as the Internet. Display apparatuses, such as computers, are positioned at predetermined positions and connected to the communication network to receive the digital signals and transform the digital signals into images for display. However, since most televisions are unable to independently transform the digital signals into images for display, they cannot be used to adjust visual monitoring parameters of IP cameras as efficiently as above method. If a computer connected to an IP camera through the communication network is used to adjust visual monitoring parameters of the IP camera as with the above method, the adjusting operation needs a complicated and expensive hardware structure.

Therefore, there is room for improvement within the art.

### BRIEF DESCRIPTION OF THE DRAWINGS

Many aspects of the present IP camera can be better understood with reference to the following drawings. The components in the various drawings are not necessarily drawn to scale, the emphasis instead being placed upon clearly illustrating the principles of the present IP camera. Moreover, in the drawings, like reference numerals designate corresponding parts throughout the figures.

The FIGURE is a block diagram of an IP camera, according to an exemplary embodiment.

### DETAILED DESCRIPTION

The FIGURE shows an IP camera 100 for visual monitoring systems, according to an exemplary embodiment. The IP camera 100 includes an image capturing unit 10, a processor unit 20, a communication unit 30, at least one distant monitoring unit 40, a coder/encoder (CODEC) unit 50, a microprogrammed Control Unit (MCU) 60, an interface 70, and a near monitoring unit 80.

The image capturing unit 10 is a digital camera module, which includes a lens module 11 and an image sensor 13 positioned in an light emitting path of the lens module 11. Images captured by the lens module 11 are transmitted to the image sensor 13, and the image sensor 13 transforms the images into electric signals.

The processor unit 20 can be a central processing unit (CPU). The communication unit 30 is a communication network access device, such as an adapter or a wireless card. The distant monitoring unit 40 is a display apparatus capable of transforming digital signals into images to display, such as a personal computer (PC). This is the ultimate user monitoring location and is typically in another location (i.e., distant from) the image capturing unit 10. The processor unit 20 is electrically connected to the image sensor 13 and the communication unit 30. The communication unit 30 is connected to a conventional communication network (not labeled), such as the Internet. Thus, the processor unit 20 can access the communication network through the communication unit 30. The distant monitoring unit 40 is connected to the communication network to communicate with the processor unit 20 through the communication module 30 and the communication network, thereby receiving signals from the processor unit 20. When the image sensor 13 generates electric signals corresponding to images, the processor unit 20 receives the electric signals and converts the electric signals into digital signals in a predetermined format, such as moving pictures experts group (MPEG) format. The digital signals are sent to the distant monitoring unit 40 through the communication unit 30 and the communication network. Upon receiving the digital signals, the distant monitoring unit 40 transforms the digital signals into images to display.

The CODEC unit 50 is electrically connected to the image sensor 13. When the image sensor 13 generates electric signals corresponding to images, the CODEC unit 50 receives the electric signals and converts the electric signals into analog signals in a predetermined format, such as a national television systems committee (NTSC) format or a phase alternating line (PAL) format. The MCU 60 is electrically connected to the CODEC unit 50. The MCU 60 can control the CODEC unit 50 to convert received electric signals into analog signals in selected formats and adjust relative parameters of analog signals in each selected format, such as brightness, colors, and definition. The interface 70 can be a bay nut connector (BNC) for transmitting analog signals. The near monitoring unit 80 is a display apparatus capable of transforming analog signals into images to display, such as a television. The near monitoring unit 80 is electrically connected to the CODEC unit 50 through the interface 70 to receive analog signals generated by the CODEC unit 50 and transforms the analog signals into images to display. The near monitoring unit 80 is typically positioned near to the image capturing unit 10 so that the image capturing unit 10 can be adjusted according to the appearance of the display of the near monitoring unit 80.

In use, the image capturing unit 10, the processor 20, the communication unit 30, the CODEC unit 50, the MCU 60, the interface 70, and the near monitoring unit 80 are all positioned at a predetermined position to be detected, and the distant monitoring unit 40 can be positioned at any position. The communication unit 30 is connected to the distant monitoring unit 40, such that the processor unit 20 communicates with the distant monitoring unit 40 through the communication unit 30 and the communication network.

When the IP camera 100 functions, images captured by the lens module 11 are transmitted to the image sensor 13, and the image sensor 13 transforms the images into electric signals. The processor unit 20 receives the electric signals and converts the electric signals into digital signals. The digital signals are sent to the distant monitoring unit 40 through the communication unit 30 and the communication network, and the distant monitoring unit 40 transforms the digital signals into images to display. Thus, the distant monitoring unit 40 can be used to remotely detect the images captured by the image capturing unit 10.

When visual monitoring parameters of the IP camera 100, such as position, visual angle, and definition, need to be adjusted, the CODEC unit 50, the MCU 60, the interface 70, and the near monitoring unit 80 can be used. The near monitoring unit 80 is first positioned near the image capturing unit 10 and the processor unit 20. The CODEC unit 50 receives the electric signals generated by the image sensor 13 and converts the electric signals into analog signals in a predetermined format. The MCU 60 can be used to select the format of the analog signals and adjust relative parameters of the analog signals. The analog signals are transmitted to the near monitoring unit 80 through the interface 70, and the near monitoring unit 80 transforms the analog signals into images to display. Since the images displayed by the near monitoring unit 80 are easy to detect, the image capturing unit 10 and the processor unit 20 can be easily operated to adjust the visual monitoring parameters according to the images displayed by the near monitoring unit 80. Thus, the IP camera 100 can be easily operated to obtain a desired monitor status.

In the IP camera 100, the near monitoring unit 80 does not need to be capable of processing digital signals, and does not need to be connected to any communication network. Thus, the IP camera 100 does not needs a complicated hardware structure and costs less. Compared with conventional IP cameras, the visual monitoring parameters of the IP camera 100 can be easily adjusted to obtain a desired monitor status.

The MCU 60 can be integrated with the processor unit 20. The at least one distant monitoring unit 40 can also be a wireless communication device capable of transforming received digital signals into images to display, such as a mobile phone or a personal digital assistant (PDA). The communication network can be a wireless communication network, such as global system mobile communication (GSM) or code division multiple access (CDMA). If the distant monitoring unit 40 is the wireless communication device, it does not need to be connected to the communication network by cables. In use, it can wirelessly communicate with the processor unit 20 through the communication unit 30 and the communication network to receive digital signals, and then transforms received digital signals into images to display.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. An Internet protocol (IP) camera, comprising:
an image capturing unit for capturing images and transforming captured images into electric signals;
a processor unit electrically connected to the image capturing unit;
a distant monitoring unit communicating with the processor unit through a communication network to receive the electric signals through the processor unit and the communication network and transforms the electric signals into images to display;
a coder/encoder (CODEC) unit electrically connected to the image capturing unit; and
a near monitoring unit positioned near the image capturing unit and connected to the CODEC unit, the near monitoring unit receiving the electric signals through the CODEC unit and transforming the electric signals into images to display, wherein the IP camera is adjusted using the images displayed by the near monitoring unit.

2. The IP camera as claimed in claim 1, wherein the processor unit converts the electric signals into digital signals in a predetermined format and transmits the digital signals to the distant monitoring unit through the communication network, and the distant monitoring unit transforms the digital signals into images to display.

3. The IP camera as claimed in claim 2, wherein the digital signals are in moving pictures experts group (MPEG) format.

4. The IP camera as claimed in claim 2, further comprising a communication unit connected to the processor unit and the communication network, the communication unit being a communication network access device, the processor unit accessing the communication network through the communication unit.

5. The IP camera as claimed in claim 4, wherein the distant monitoring unit is a computer, and the communication network is the Internet.

6. The IP camera as claimed in claim 4, wherein the distant monitoring unit is a wireless communication device, and the communication network is a wireless communication network.

7. The IP camera as claimed in claim 1, wherein the CODEC unit converts the electric signals into analog signals in a predetermined format and transmits the analog signals to the near monitoring unit, and the near monitoring unit transforms the analog signals into images to display.

8. The IP camera as claimed in claim 7, wherein the analog signals are in national television systems committee (NTSC) format or phase alternating line (PAL) format.

9. The IP camera as claimed in claim 7, further comprising a microprogrammed Control Unit (MCU) connected to the CODEC unit, wherein the MCU controls the CODEC unit to convert received electric signals into analog signals in selected formats and adjust relative parameters of analog signals in each selected format.

10. The IP camera as claimed in claim 7, further comprising an interface, the interface being a bay nut connector (BNC), the near monitoring unit connected to the CODEC unit through the interface.

11. The IP camera as claimed in claim 7, wherein the near monitoring unit is a television.
